(19) United States
(12) Patent Application Publication
(10) Pub. No.: US 2021/0027758 A1
(43) Pub. Date: Jan. 28, 2021

(54) SIGNAL PROCESSING APPARATUS, SIGNAL PROCESSING METHOD, AND SIGNAL PROCESSING PROGRAM

(71) Applicant: Sony Corporation, Tokyo (JP)

(72) Inventors: Shinpei Tsuchiya, Saitama (JP); Shigetoshi Hayashi, Tokyo (JP); Kohei Asada, Kanagawa (JP); Kazunobu Ookuri, Kanagawa (JP)

(73) Assignee: Sony Corporation, Tokyo (JP)

(21) Appl. No.: 17/045,157

(22) PCT Filed: Apr. 1, 2019
(86) PCT No.: PCT/JP2019/014501

§ 371 Date: Oct. 2, 2020

(30) Foreign Application Priority Data
Apr. 9, 2018 (JP) 2018-074492

(51) Int. Cl. G10K 11/178

(52) U.S. Cl. CPC G10K 11/178

(57) ABSTRACT

A signal processing apparatus that performs noise cancellation processing for reducing noise by selecting, from among a plurality of input units and a plurality of output units that respectively correspond to the plurality of input units, the input unit and the output unit to be used in noise cancellation processing.

### TECHNICAL FIELD

The present technique relates to a signal processing apparatus, a signal processing method, and a signal processing program.

### BACKGROUND ART

Conventionally, a method of noise cancellation of performing noise reduction in a closed space using predetermined numbers of speakers and microphones is proposed (PTL 1).

In order to control noise in a specific space, unlike a system configuration based on a single input as in noise cancellation in headphones, a Multi Input Multi Output system configuration that is constituted by several tens of channels or several hundreds of channels is necessary to cause a plurality of noise reduction apparatuses to interact with each other.

### CITATION LIST

### Patent Literature

[PTL 1]

JP 2015-080199A

### SUMMARY

### Technical Problem

However, for example, when performing noise reduction of a large space such as a residence or a public space, arithmetic processing must be enabled by evenly arranging microphones and speakers in the space. Since a general-purpose AD converter, a general-purpose processing unit, and a general-purpose DA converter are only capable of accommodating several ten channels at the most, when a size of a processing object space and signal processing resources are taken into consideration, a case where several tens of channels to several hundreds of channels are required has a problem in that the numbers of AD converters, processing units, DA converters, and the like to be used increase proportionally and that a scale of a system becomes excessively large.

The present technique has been devised in consideration of the problem described above and an object thereof is to provide a signal processing apparatus, a signal processing method, and a signal processing program which enable noise reduction to be performed using smaller numbers of microphones and speakers than microphones and speakers that are being arranged.

### Solution to Problem

In order to solve the problem described above, a first technique is a signal processing apparatus that performs noise cancellation processing for reducing noise by selecting, from among a plurality of input units and a plurality of output units that respectively correspond to the plurality of input units, an input unit and an output unit to be used in the noise cancellation processing.

In addition, a second technique is a signal processing method including performing noise cancellation processing for reducing noise by selecting, from among a plurality of input units and a plurality of output units that respectively correspond to the plurality of input units, an input unit and an output unit to be used in noise cancellation processing.

Furthermore, a third technique is a signal processing program that causes a computer to execute a signal processing method including performing noise cancellation processing for reducing noise by selecting, from among a plurality of input units and a plurality of output units that respectively correspond to the plurality of input units, an input unit and an output unit to be used in the noise cancellation processing.

### Advantageous Effects of Invention

According to the present technique, noise reduction can be performed using smaller numbers of microphones and speakers than microphones and speakers that have been arranged. It should be noted that the advantageous effect described above is not necessarily restrictive and any of the advantageous effects described in the specification may apply.

### BRIEF DESCRIPTION OF DRAWINGS

FIG. 1 is a block diagram illustrating a configuration of a signal processing apparatus according to an embodiment of the present technique.

FIG. 2 is a diagram illustrating an arrangement example of microphones and speaker according to the present technique.

FIG. 3 is a block diagram illustrating a configuration according to a first aspect of a noise information acquiring unit.

FIG. 4 is a diagram illustrating a first example of sound signal supply to the noise information acquiring unit.

FIG. 5 is a diagram of sound pressure level comparison processing according to the first aspect of the noise information acquiring unit.

FIG. 6 is a diagram illustrating a second example of sound signal supply to the noise information acquiring unit.

FIG. 7 is a diagram illustrating a third example of sound signal supply to the noise information acquiring unit.

FIG. 8 is an explanatory diagram of a position of a noise source and selected channels according to the first aspect of the noise information acquiring unit.

FIG. 9 is a diagram for explaining selection of channels when a position of the noise source moves.

FIG. 10 is a diagram for explaining a comparison between frequency characteristics and a reference of noise.

FIG. 11 is an explanatory diagram of channel selection according to a second aspect of the noise information acquiring unit.

FIG. 12 is an explanatory diagram of channel selection according to a third aspect of the noise information acquiring unit.

FIG. 13 is a diagram illustrating an example of an image to be supplied to the noise information acquiring unit.

FIG. 14A is a diagram illustrating an arrangement example of microphones and speakers when using a feedforward system, and FIG. 14B is a diagram illustrating an arrangement example of microphones and speakers when using both a feedforward system and a feedback system.

FIG. 15 is a diagram illustrating a modification of the signal processing apparatus.

FIG. 16 is a diagram illustrating a modification of the signal processing apparatus.

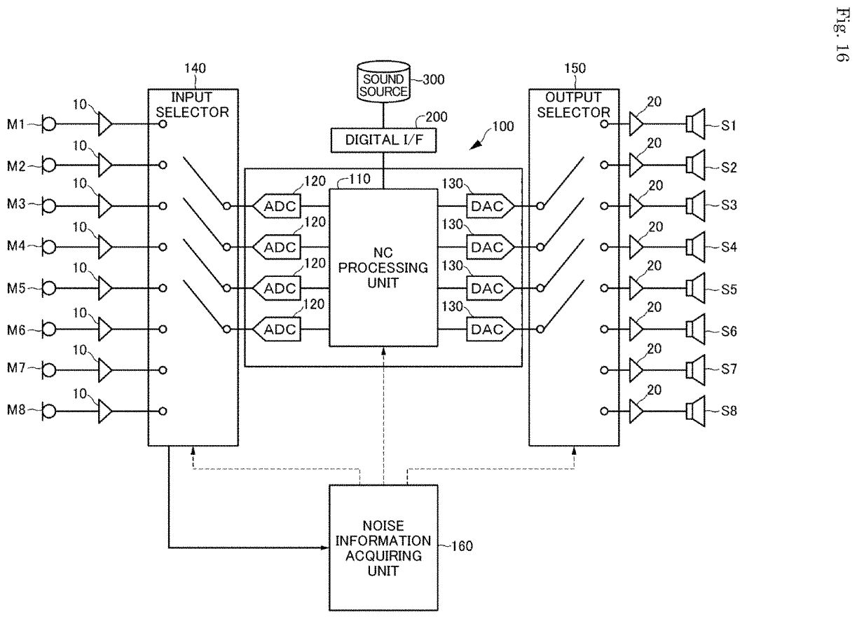

### DESCRIPTION OF EMBODIMENTS

Hereinafter, an embodiment of the present technique will be described with reference to the drawings. The description will be given in the following order.

<1. Embodiment>

[1-1. Configuration of signal processing apparatus]

[1-2. Processing by signal processing apparatus]

[1-2-1. First aspect of processing]

[1-2-2. Second aspect of processing]

[1-2-3. Third aspect of processing]

[1-2-4. Fourth aspect of processing]

<2. Modifications>

### 1. Embodiment

### 1-1. Configuration of Signal Processing Apparatus

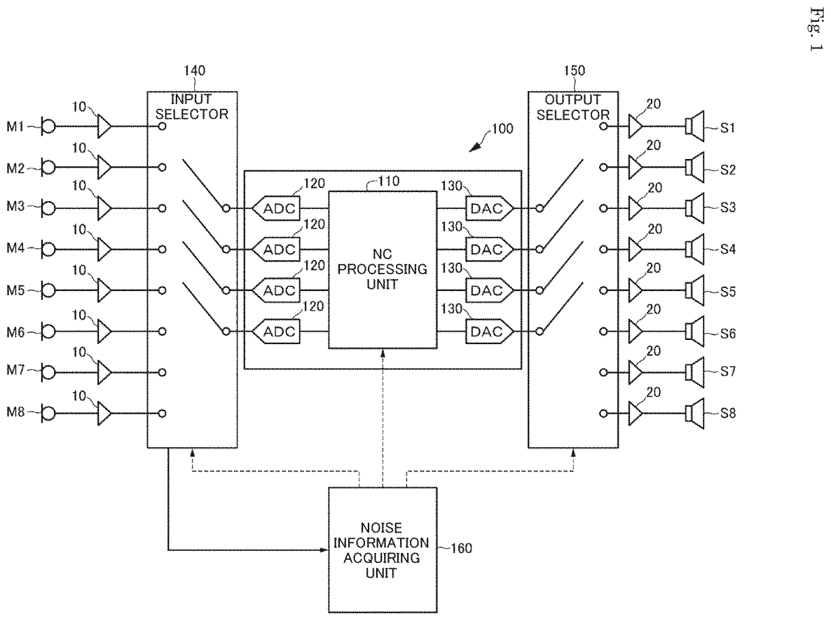

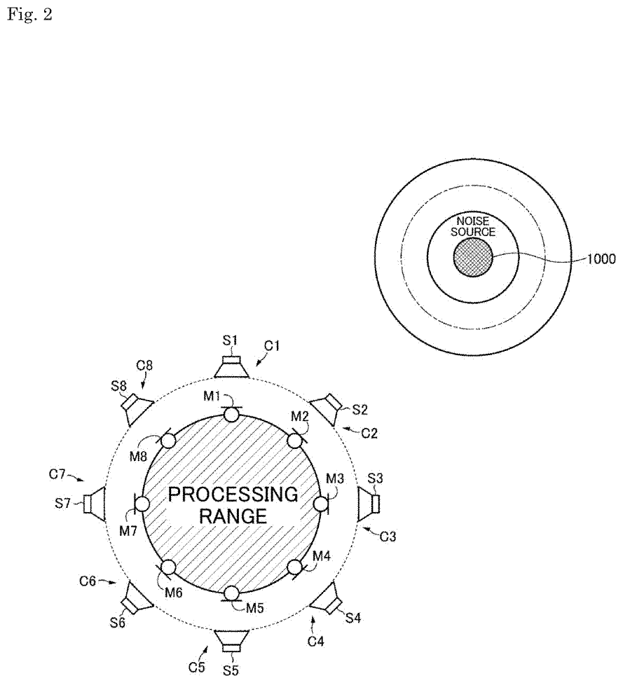

First, a configuration of a signal processing apparatus 100 will be described with reference to FIGS. 1 and 2. The signal processing apparatus 100 is configured to include a noise cancellation processing unit 110, an AD (Analog/Digital) converter 120, a DA (Digital/Analog) converter 130, an input selector 140, an output selector 150, and a noise information acquiring unit 160. It should be noted that, in FIG. 1, a solid line indicates a sound signal and an audio signal (hereinafter, referred to as a cancellation signal) for noise reduction and a dashed line indicates a control signal or an information transmission signal.

The input selector 140 is connected to the noise cancellation processing unit 110 of the signal processing apparatus 100 via a plurality of AD converters 120. In addition, the output selector 150 is connected to the noise cancellation processing unit 110 via a plurality of DA converters 130. Microphones M1 to M8 are connected to the input selector 140 via eight microphone amplifiers 10. In addition, speakers S1 to S8 are connected to the output selector 150 via eight power amplifiers 20. The numbers of microphones and speakers are not limited thereto and may be equal to or greater than 8 or equal to or smaller than 8, and several tens or several hundreds of microphones and speakers can be connected to the signal processing apparatus 100. A microphone corresponds to the input unit in the claims and a speaker corresponds to the output unit in the claims.

In the present embodiment, as shown in FIG. 2, the microphones M1 to M8 and the speakers S1 to S8 are arranged in annular arrays so as to surround a space (hereinafter, referred to as a processing range) that is an object of noise reduction processing. A microphone and a speaker correspond to each other as a pair to constitute a channel, and are provided in the same number.

In the following description, it is assumed that a channel C1 is constituted by the microphone M1 and the speaker S1. It is assumed that a channel C2 is constituted by the microphone M2 and the speaker S2. It is assumed that a channel C3 is constituted by the microphone M3 and the speaker S3. It is assumed that a channel C4 is constituted by the microphone M4 and the speaker S4. It is assumed that a channel C5 is constituted by the microphone M5 and the speaker S5. It is assumed that a channel C6 is constituted by the microphone M6 and the speaker S6. It is assumed that a channel C7 is constituted by the microphone M7 and the speaker S7. It is assumed that a channel C8 is constituted by the microphone M8 and the speaker S8.

As described above, a plurality of inputs and a plurality of outputs are connected to the signal processing apparatus 100. Therefore, the signal processing apparatus 100 is configured as a Multi Input-Multi Output apparatus. The plurality of inputs and the plurality of outputs enable noise emitted from a noise source 1000 to be reduced in a processing range to be an object of noise cancellation processing.

The microphone collects sound and noise within the processing range to be an object of noise reduction by the signal processing apparatus 100. A sound signal based on a sound collection result by the microphone is subjected to gain adjustment by a microphone amplifier 10 and supplied to the AD converter 120 via the input selector 140. In addition, the sound signal from the microphone is also supplied to the noise information acquiring unit 160 to be used in noise information acquisition by the noise information acquiring unit 160. Details of supply of the sound signal to the noise information acquiring unit 160 will be described later.

The input selector 140 switches among input-side channels by selecting a microphone for supplying a sound signal to the AD converter 120 among a plurality of connected microphones. In the present embodiment, the input selector 140 is capable of simultaneously supplying four channels' worth of sound signals to each of four AD converters 120. Switching among channels by the input selector 140 is performed under control by the noise information acquiring unit 160.

According to the present technique, instead of sound signals being simultaneously supplied to the noise cancellation processing unit 110 from all microphones, sound signals are supplied to the noise cancellation processing unit 110 from fewer than all of the microphones.

The AD converter 120 converts a sound signal that is an analog signal into a digital signal and supplies the digital signal to the noise cancellation processing unit 110. In the present embodiment, the signal processing apparatus 100 includes four AD converters 120.

The noise cancellation processing unit 110 includes a digital filter for generating a cancellation signal for noise reduction. The noise cancellation processing unit 110 uses the supplied digital sound signal to generate a cancellation signal with characteristics in accordance with a filter coefficient as a predetermined parameter and supplies the cancellation signal to the DA converter 130. The noise cancellation processing unit 110 is constituted by a DSP (Digital Signal Processor) or the like.

Alternatively, the signal processing apparatus 100 may be constituted by a program, in which case the program may be installed in advance into a processor such as a DSP or a computer that performs signal processing or may be downloaded or distributed by a recording medium to be installed by a user himself/herself. In addition, besides being realized by a program, the signal processing apparatus 100 may be realized by a combination of a dedicated apparatus made up of hardware, a circuit, and the like having functionality of the signal processing apparatus 100.

The DA converter 130 converts the supplied cancellation signal into an analog signal and supplies the analog signal to the output selector 150. The cancellation signal is supplied to the power amplifier 20 via the output selector 150, supplied to a speaker from the power amplifier 20, and output from the speaker. Accordingly, noise in the processing range can be reduced. A speaker corresponds to the output unit according to the claims In the present embodiment, eight speakers S1 to S8 are connected to the output selector 150 via eight power amplifiers 20. In addition, four DA converters 130 are provided.

The output selector 150 switches among output-side channels by selecting a speaker to which the cancellation signal generated by the noise cancellation processing unit 110 is to be supplied among a plurality of speakers. In the present embodiment, the output selector 150 is capable of simultaneously supplying four channels' worth of cancellation signals to each of four speakers. Switching among channels by the output selector 150 is performed under control by the noise information acquiring unit 160.

A supply destination of a cancellation signal from the output selector 150 is set to a speaker corresponding to a channel of the microphone selected by the input selector 140. In other words, a cancellation signal generated using a sound signal from the microphone M1 when the channel C1 is selected is supplied to the speaker S1 of the channel C1. In a similar manner, a cancellation signal generated using a sound signal from the microphone M8 when the channel C8 is selected is supplied to the speaker S8 of the channel C8.

In the present technique, cancellation signals are not simultaneously output from all speakers but, instead, cancellation signals are output from fewer than all speakers.

The noise information acquiring unit 160 is constituted by a DSP or the like and acquires information (hereinafter, referred to as noise information) related to noise. Details of noise information will be provided later. In addition, the noise information acquiring unit 160 holds a table which associates, in advance, channels to be selected by the input selector 140 and the output selector 150 and noise information, and the noise information acquiring unit 160 refers to the table to determine channels to be selected by the input selector 140 and the output selector 150. When the channel to be selected is determined, the noise information acquiring unit 160 transmits a predetermined control signal to the input selector 140 and the output selector 150. The input selector 140 selects a microphone for supplying a sound signal to the AD converter 120 by switching internal switches based on the control signal from the noise information acquiring unit 160. The output selector 150 selects a speaker for supplying a cancellation signal by switching internal switches based on the control signal from the noise information acquiring unit 160. Details of processing by the noise information acquiring unit 160 will be provided later.

A signal processing system that includes the signal processing apparatus 100 is configured as described above. It should be noted that the numbers of microphones and speakers shown in FIG. 2 simply represent an example and the present technique is not limited to these numbers. The numbers of microphones and speakers may be increased or reduced in accordance with a size of the processing range that is an object of noise reduction.

In a conventional noise reduction system, normally, all microphones and speakers are connected to a noise cancellation processing unit to simultaneously process all signals. However, since the number of input channels of a DSP or the like that constitutes the noise cancellation processing unit is finite, it is difficult to simultaneously connect all microphones to the DSP. In consideration thereof, in the present technique, by dynamically switching among channels constituted by a pair of a microphone and a speaker to be actually used based on noise information, noise reduction is performed with limited computing resources.

The present technique is usable in all environments as long as an object of use is to reduce noise in a space. For example, the present technique can be applied to a room of a residence to reduce noise that enters the room from outside of the residence or noise generated inside the room. In addition, by adjusting a scale of the signal processing system by increasing or reducing the numbers of microphones and speakers in accordance with a size of the room, noise can be adequately reduced even when the room is large. Alternatively, the present technique can be applied to a vehicle to reduce noise from outside of the vehicle or noise generated inside the vehicle.

Noise-cancellation systems can be roughly divided into a feedforward system and a feedback system.

The feedforward system refers to a system in which noise is collected by a microphone to obtain a noise signal, the noise signal is subjected to predetermined signal processing to generate a cancellation signal, and the cancellation signal is output from a speaker or the like to reduce noise. The feedforward system requires a reference microphone for collecting noise.

In the feedback system, noise is collected together with sound reproduced within a processing range by a microphone, and the sound signal is subjected to predetermined signal processing to generate a cancellation signal. In addition, the cancellation signal is output from a speaker or the like to reduce noise.

### 1-2. Processing by Signal Processing Apparatus

### 1-2-1. First Aspect of Processing

Next, a first aspect of processing by the noise information acquiring unit 160 will be described. In the first aspect, the noise information acquiring unit 160 performs processing of acquiring a position of a noise source that is a generation source of noise based on a sound signal supplied from a microphone and determining a channel to be selected.

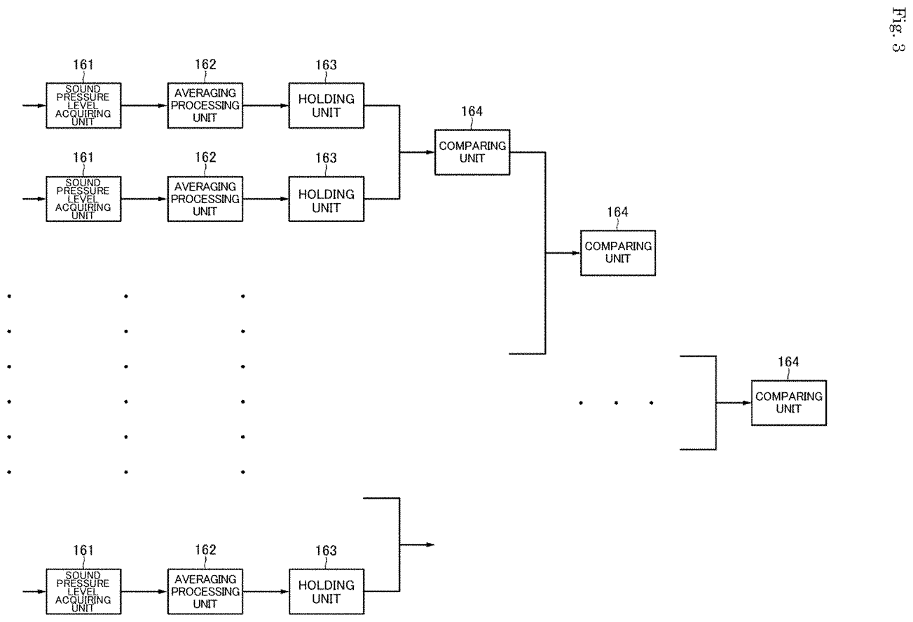

First, processing of acquiring a position of a noise source by the noise information acquiring unit 160 will be described. FIG. 3 is a diagram illustrating a block configuration of the noise information acquiring unit 160. The noise information acquiring unit 160 is configured to include pluralities of sound pressure level acquiring units 161, averaging processing units 162, holding units 163, and comparing units 164.

The sound pressure level acquiring unit 161 acquires a sound pressure level of a sound signal supplied from a microphone and supplies the averaging processing unit 162 with the sound pressure level. The averaging processing unit 162 calculates a time-average value of the sound pressure level of a sound signal. A time-average value of a gain of the sound signal having been calculated by the averaging processing unit 162 is to be an object of comparison by the comparing unit 164. The holding unit 163 holds the time-average value of the gain of the sound signal for a predetermined time and supplies the time-average value to the comparing unit 164 at a predetermined timing. Since sound is not always simultaneously input to the microphone of each channel and normally has a time difference, the purpose here is to supply the time-average value to be a comparison object to the comparing unit 164 at an adequate timing.

In the noise information acquiring unit 160, the plurality of comparing units 164 are configured to form a step-ladder multi-stage structure. When the time-average value of the gain of the sound signal of each adjacent channel is input, the comparing unit 164 compares the time-average values and supplies a larger time-average value to a next comparing unit 164.

As a result of performing channel-for-channel comparisons by the plurality of comparing units 164, a single channel with a highest sound pressure level is determined. In addition, the noise information acquiring unit 160 determines a microphone of the channel with the highest sound pressure level as a microphone that is closest to the noise source. In other words, a position of the noise source is acquired on the assumption that the noise source is in a vicinity of the microphone of the channel with the highest sound pressure level. This is because noise should be input at the highest sound pressure level to the microphone that is closest to the noise source. In this manner, the noise information acquiring unit 160 acquires the position of the noise source by estimation based on sound pressure levels.

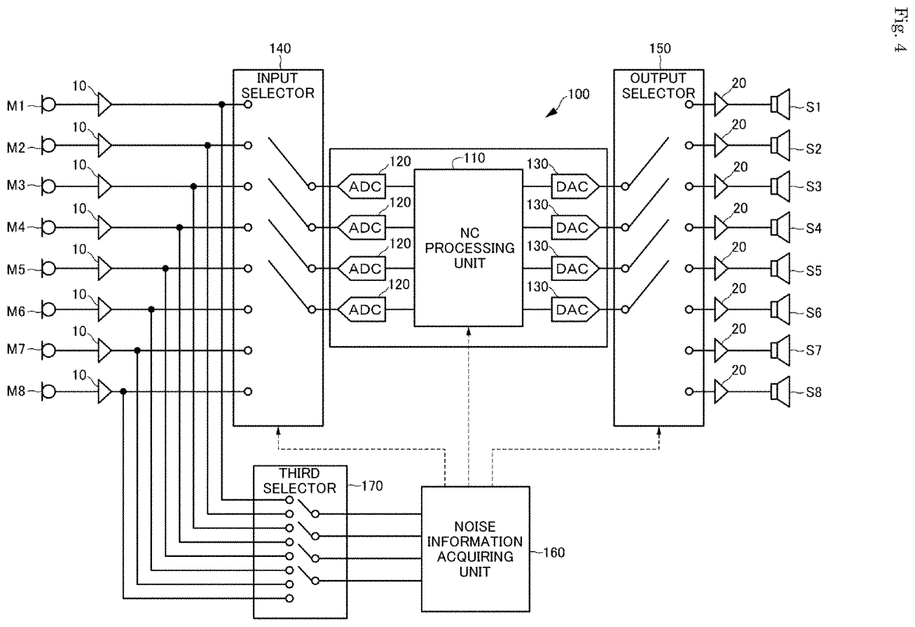

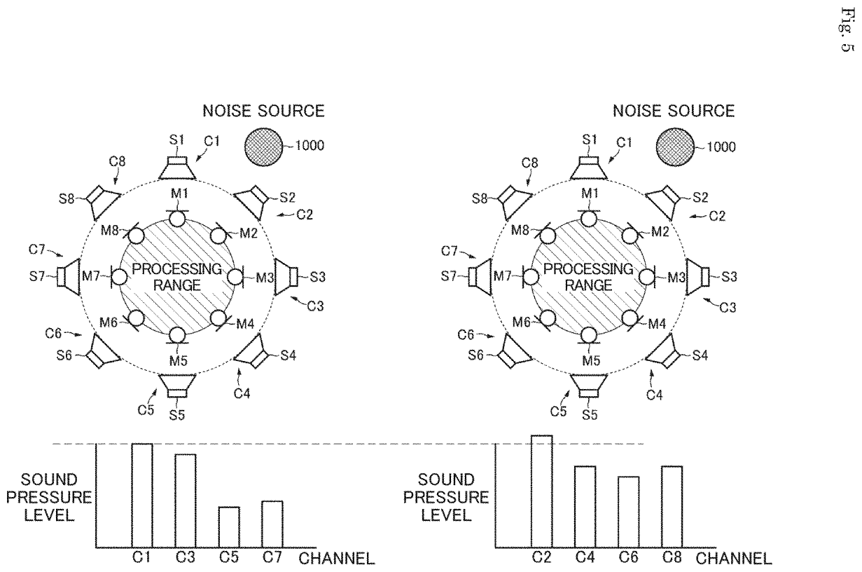

Next, supply of a sound signal from a microphone to the noise information acquiring unit 160 will be described with reference to FIGS. 4 and 5.

FIG. 4 represents a first example of sound signal supply to the noise information acquiring unit 160. In the first example, a third selector 170 is provided between the noise information acquiring unit 160 and the microphone amplifier 10. The third selector 170 selects a plurality of sound signals from among the sound signals from the microphones M1 to M8 of all channels and supplies the selected plurality of sound signals to the noise information acquiring unit 160.

In the first example, sound signals of a plurality of channels among all channels (in FIG. 4, four channels among eight channels) are simultaneously supplied to the noise information acquiring unit 160 via the third selector 170. Sound signals of all channels are not simultaneously supplied to the noise information acquiring unit 160 and comparisons of sound pressure levels of all channels are not simultaneously performed. Simultaneously performing processing with respect to the sound signals from all channels requires the noise information acquiring unit 160 to include as many sound pressure level acquiring units 161, averaging processing units 162, and holding units 163 as the number of channels, thereby increasing the system using the present technique as well as increasing cost.

Normally, since noise is continuously produced and noise sources rarely move frequently, the need to simultaneously processing sound signals from all channels is conceivably low. Therefore, a position of a noise source can be acquired even when all sound signals are processed in stages instead of simultaneously.

In consideration thereof, as shown in FIG. 5, first, sound signals of odd-numbered channels are supplied to the noise information acquiring unit 160 to perform sound pressure level acquisition and averaging processing of the sound signals of odd-numbered channels. Next, switching of the third selector 170 is performed, and sound signals of even-numbered channels are supplied to the noise information acquiring unit 160 to perform sound pressure level acquisition and averaging processing of the sound signals of even-numbered channels. In addition, a sound signal with a highest sound pressure level among the sound signals of all channels is determined by comparison processing by a plurality of comparing units 164.

While the sound signals of odd-numbered channels are supplied to the noise information acquiring unit 160 and the sound signals of even-numbered channels are next supplied to the noise information acquiring unit 160 in FIG. 5, a supply order is not limited to this order and after first supplying the sound signals of even-numbered channels, the sound signals of odd-numbered channels may be supplied. In addition, instead of dividing channels into odd numbers and even numbers, in an order of numbers of the channels, sound signals of the channel C1, the channel C2, the channel C3, and the channel C4 may be supplied first and sound signals of the channel C5, the channel C6, the channel C7, and the channel C8 may be supplied afterward.

In addition, instead of dividedly supplying sound signals to the noise information acquiring unit 160 in two stages, the sound signals may be dividedly supplied in three or more stages. Instead of simultaneously supplying sound signals from microphones of all channels to the noise information acquiring unit 160, channels may be selected by the third selector 170 in any way as long as the sound signals of all channels are finally supplied to the noise information acquiring unit 160.

When as many sound signals as the number of channels cannot be simultaneously processed by the noise information acquiring unit 160, the third selector 170 may be provided between the noise information acquiring unit 160 and the microphone amplifier 10 as described above. Providing the third selector 170 enables sound signals to be dividedly supplied to the noise information acquiring unit 160 in a plurality of stages and the sound signals of all channels to be finally supplied to the noise information acquiring unit 160 to be processed.

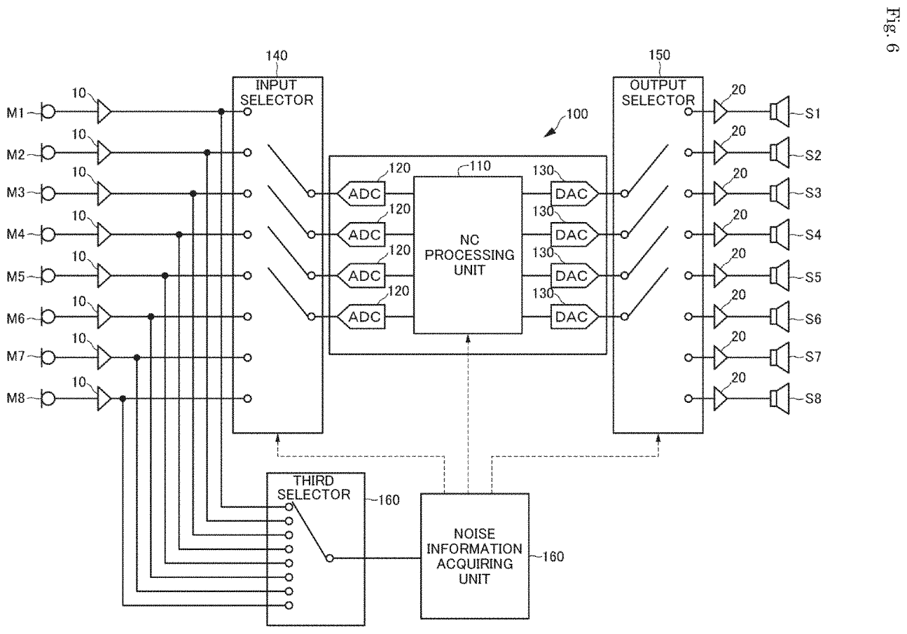

FIG. 6 represents a second example of sound signal supply to the noise information acquiring unit 160. In the second example, sound signals are supplied to the third selector 170 from microphones of all channels and the third selector 170 sequentially selects one channel at a time and supplies a sound signal to the noise information acquiring unit 160. In addition, finally, the sound signals of the microphones of all channels are supplied to the noise information acquiring unit 160.

In the second example, the noise information acquiring unit 160 performs gain calculation and averaging processing for each channel. In the second example, acquisition of a position of a noise source is performed including sound signals of channels other than the channels of which a sound signal is supplied to the noise cancellation processing unit 110. In this case, the noise information acquiring unit 160 performs sound pressure level acquisition and averaging processing with respect to a supplied sound signal of a channel, and holds a sound pressure level of sound signals with the holding unit 163 until sound pressure level acquisition and averaging processing on sound signals of all channels are completed. In addition, once sound pressure levels of sound pressure levels of all channels have been obtained, comparison processing by the comparing unit 164 is performed, a sound signal with a highest sound pressure level is determined, and the position of the noise source is acquired.

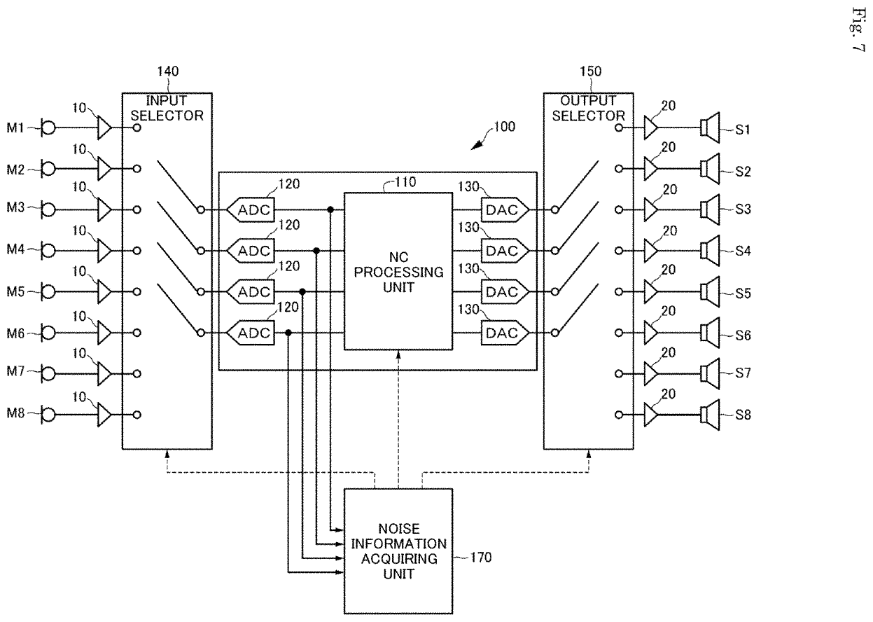

FIG. 7 represents a third example of sound signal supply to the noise information acquiring unit 160. In the third example, a sound signal which is selected by the input selector 140 and which is supplied to the noise cancellation processing unit 110 via the AD converter 120 is supplied to the noise information acquiring unit 160. In the third example, acquisition of noise information is performed based only on a sound signal which is selected by the input selector 140 and which is supplied to the noise cancellation processing unit 110.

It should be noted that, in the third example, a sound signal is not supplied to the noise information acquiring unit 160 unless any channel is first selected. Therefore, a channel of which a sound signal is to be first supplied by default to the noise cancellation processing unit 110 and the noise information acquiring unit 160 may be set, and an adequate channel may be selected after acquiring noise information based on the supplied sound signal.

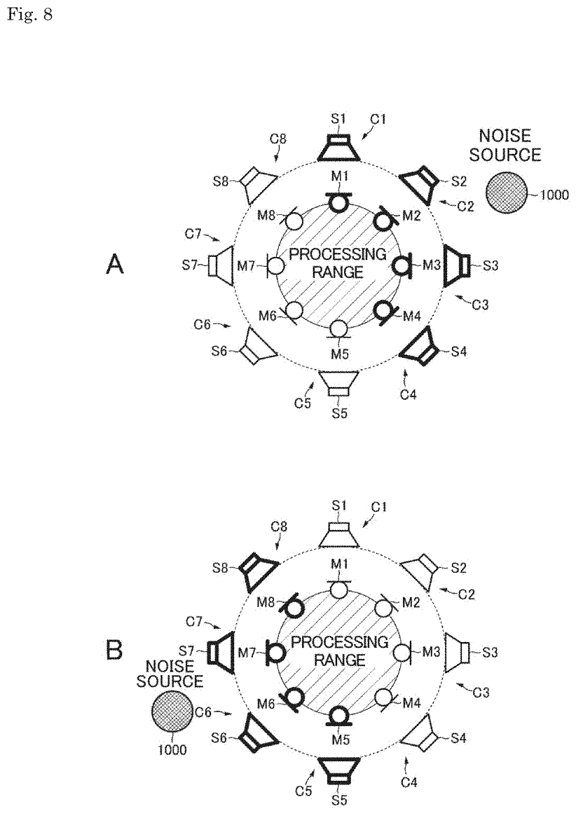

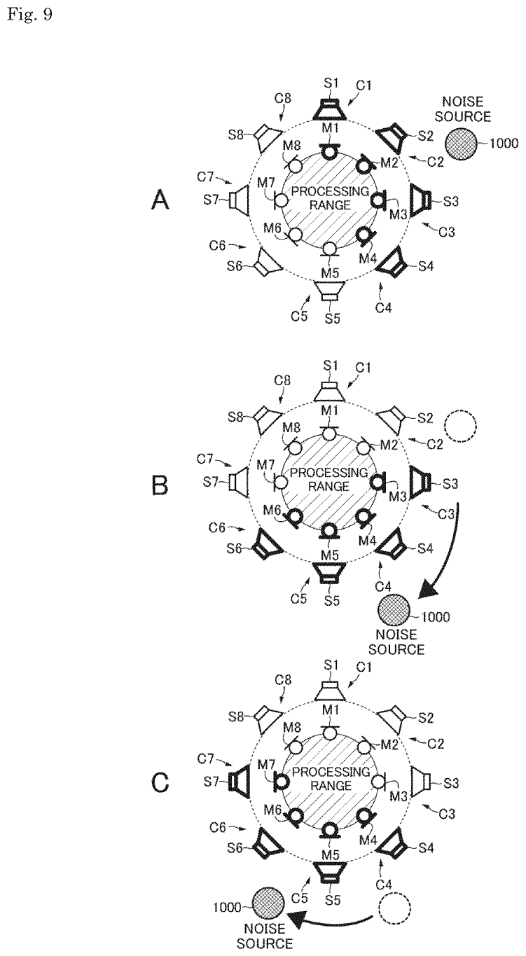

Acquisition of a position of a noise source and selection of channels based on the position of the noise source according to the first aspect are performed as described above. According to the present technique, for example, when the noise source 1000 is present at position shown in FIG. 8A, the channels C1, C2, C3, and C4 which are positioned in a vicinity of the noise source 1000 are selected and sound signals are supplied to the noise cancellation processing unit 110 from the microphones M1, M2, M3, and M4. In addition, the output selector 150 supplies cancellation signals to the speakers S1, S2, S3, and S4. It should be noted that, in FIG. 8 and FIGS. 9, 11, and 12 subsequent to FIG. 8, microphones M and speakers S depicted by bold lines represent microphones and speakers of selected channels C.

In addition, when the noise source 1000 is present at position shown in FIG. 8B, the channels C5, C6, C7, and C8 which are positioned in a vicinity of the noise source 1000 are selected, the microphones M5, M6, M7, and M8 are selected, and sound signals are supplied to the noise cancellation processing unit 110. Furthermore, the output selector 150 supplies cancellation signals to the speakers S5, S6, S7, and S8. Concentrating selected channels on channels near a noise source in this manner enables noise reduction to be performed in an efficient manner.

It should be noted that FIG. 8 does not indicate that four channels positioned in the vicinity of the noise source 1000 are to be always selected, and the selection of the four channels merely represent an example. How many channels are to be selected from among channels positioned in the vicinity of the noise source 1000 may be determined based on various patterns having been stored in advance in a table based on a distance of the noise source 1000, a sound pressure level of noise, and the like.

By continuously performing selection processing of channels as described above, even when the noise source 1000 moves as shown in FIG. 9, a channel to be used in noise cancellation processing can be switched to another channel so as to follow the noise source 1000. In FIG. 9, at a time point where the noise source 1000 is at a first position shown in FIG. 9A, the channels C1, C2, C3, and C4 are used to supply sound signals from the microphones M1, M2, M3, and M4 to the AD converter 120 and to supply cancellation signals to the speakers S1, S2, S3, and S4.

In addition, when the noise source 1000 moves to a second position as shown in FIG. 9B, the noise information acquiring unit 160 acquires a position of the noise source 1000 after the movement and switching of channels to be used is performed in accordance with the second position of the noise source 1000. In FIG. 9B, in accordance with the second position of the noise source 1000, the channels C3, C4, C5, and C6 are used to supply sound signals from the microphones M3, M4, M5, and M6 to the AD converter 120 and to supply cancellation signals to the speakers S3, S4, S5, and S6.

Furthermore, when the noise source 1000 moves to a third position as shown in FIG. 9C, the noise information acquiring unit 160 acquires a position of the noise source 1000 after the movement and switching of channels to be used is performed in accordance with the third position of the noise source 1000. In FIG. 9C, in accordance with the third position of the noise source 1000, the channels C4, C5, C6, and C7 are used to supply sound signals from the microphones M4, M5, M6, and M7 to the AD converter 120 and to supply cancellation signals to the speakers S4, S5, S6, and S7.

As described above, even if a position of a noise source moves, microphones and speakers for noise reduction are selected so as to follow the noise source and noise in a processing range can be effectively reduced using limited computing resources.

### 1-2-2. Second Aspect of Processing

Next, a second aspect of processing by the noise information acquiring unit 160 will be described. In the second aspect, the noise information acquiring unit 160 has a function of an analyzer which analyzes noise and acquires frequency characteristics as noise information.

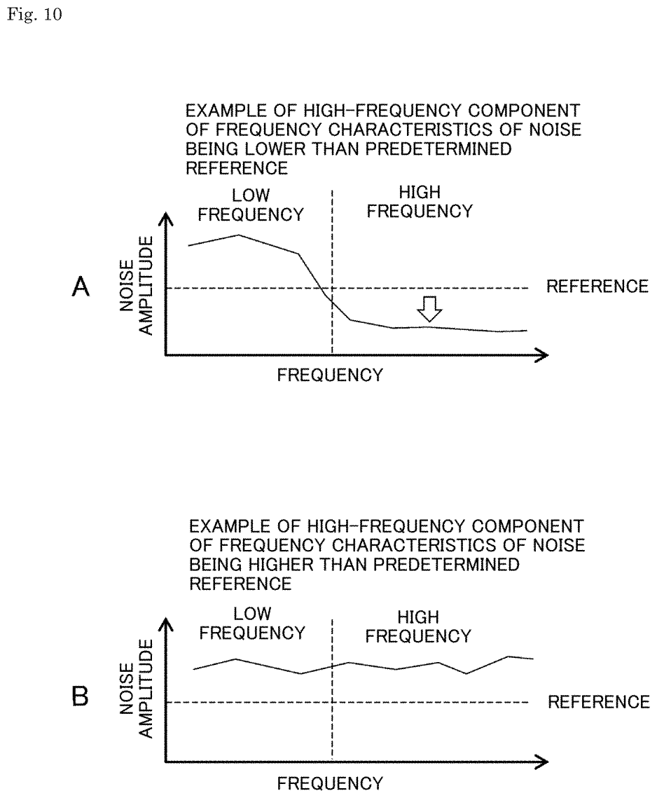

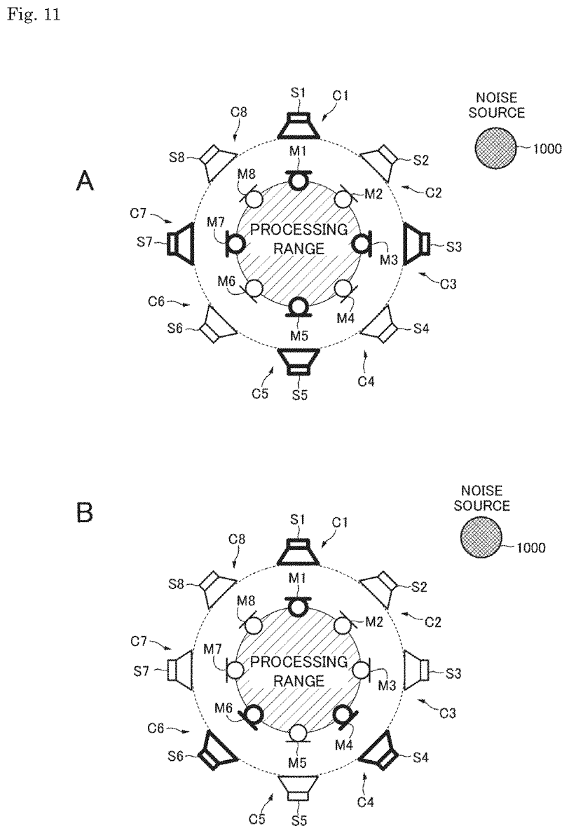

The noise information acquiring unit 160 holds a table that associates, in advance, frequency characteristics and channels to be selected. In the table, a channel to be selected is associated for each frequency band of noise. In the processing range, when a high-frequency component of the frequency characteristics of noise is lower than a predetermined reference determined in advance as shown in FIG. 10A, the channels C are selected so that the microphones M that supply sound signals to the noise cancellation processing unit 110 and the speakers S that output cancellation signals are approximately uniformly arranged as shown in FIG. 11.

Examples of approximately uniformly arranging the microphones and the speakers include selecting every other microphone and every other speaker when the microphones M and the speakers S are arranged at regular intervals as shown in FIG. 11A. However, examples of an approximately uniform arrangement are not limited to the arrangement shown in FIG. 11A and an arrangement such as that shown in FIG. 11B may be adopted instead.

This is due to characteristics of sound in that a low-pitched range has lower directionality as compared to a high-pitched range and sound is produced so as to spread across an entire space. When noise is being produced so as to spread across an entire space, performing noise cancellation processing by approximately uniformly acquiring sound signals from the entire space enables noise in the space to be adequately reduced.

When a sound signal acquired by a microphone is supplied to the noise information acquiring unit 160, the noise information acquiring unit 160 performs existing sound analysis processing to acquire frequency characteristics of noise and refers to a table to determine a channel to be selected.

In addition, once the channel to be selected is determined, the noise information acquiring unit 160 supplies a predetermined control signal to the input selector 140 and the output selector 150. Based on the control signal, the input selector 140 performs switching of a microphone to be selected. In a similar manner, based on the control signal, the output selector 150 performs switching of a speaker to be selected.

The second aspect of processing by the noise information acquiring unit 160 is configured as described above. According to the second aspect, when the high-frequency component of the frequency characteristics of noise is lower than a predetermined reference determined in advance, low-pitched sound that spreads across an entire space can be adequately reduced without using all of the arranged channels.

It should be noted that supply of sound signals from a microphone to the noise information acquiring unit 160 according to the second aspect is similar to the first to third examples of sound signal supply to the noise information acquiring unit 160 which have been described in the first aspect.

### 1-2-3. Third Aspect of Processing

Next, a third aspect of processing by the noise information acquiring unit 160 will be described. In the third aspect, the noise information acquiring unit 160 acquires directionality of noise as noise information. The directionality of noise can be acquired using various methods. For example, the noise information acquiring unit 160 can acquire sound signals from all microphones arranged in a space, measure a sound pressure level of each sound signal, and determine directionality in a direction where a microphone with an extremely high sound pressure level (for example, having a difference equal to or larger than a predetermined value from a sound pressure level of a sound signal from another microphone) is present to be high.

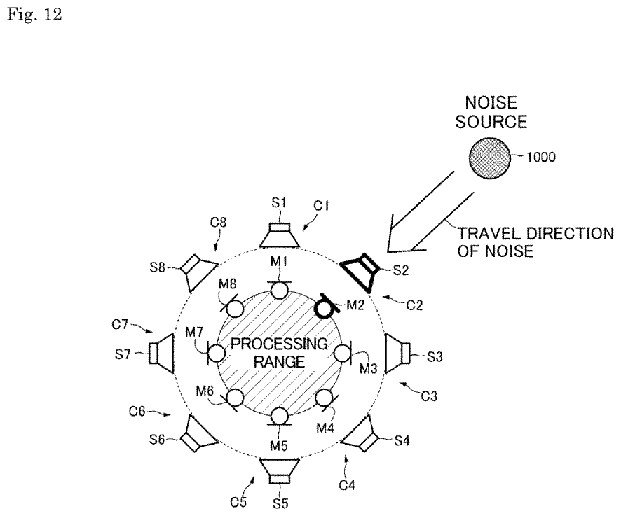

The noise information acquiring unit 160 holds a table that associates, in advance, an arrangement of microphones and speakers that constitute channels, directionality of noise with respect to the arrangements, and channels to be selected. For example, as shown in FIG. 12, a channel is selected so that a sound signal from a microphone of a channel positioned on an extension of a direction with high directionality of noise is supplied to the noise cancellation processing unit 110 and a cancellation signal is supplied to a speaker. In the example shown in FIG. 12, the microphone M2 and the speaker S2 of the channel C2 that exist in a direction of travel of noise are selected.

On the other hand, even when noise with high directionality could not be acquired, noise is conceivably produced so as to spread across an entire processing range. In such a case, channels are selected so that the microphones that supply a sound signal to the noise cancellation processing unit 110 and the speakers that output cancellation signals are approximately uniformly arranged in a processing object space. An approximately uniform arrangement is an arrangement such as that described with reference to FIG. 11.

When a sound signal acquired by a microphone is supplied to the noise information acquiring unit 160, the noise information acquiring unit 160 acquires directionality of noise and refers to a table to determine a channel to be selected.

In addition, once the channel to be selected is determined, the noise information acquiring unit 160 supplies a predetermined control signal to the input selector 140 and the output selector 150. Based on the control signal, the input selector 140 performs switching of the microphone M to be selected. In a similar manner, based on the control signal, the output selector 150 performs switching of the speaker S to be selected.

The third aspect of processing by the noise information acquiring unit 160 is configured as described above. According to the third aspect, when noise has high directionality and travels in a certain direction, using microphones and speakers that are present in the direction enables noise to be adequately reduced.

In addition, since noise can be reduced using only microphones and speakers that are arranged in a direction in which noise arrives, microphones and speakers that are arranged in directions other than the direction in which noise arrives need not be used. In this manner, noise reduction performance does not decline even when channels that do not contribute toward noise reduction are not used, and noise reduction can be performed efficiently in terms of resources, power, and cost. While the microphone M6 and the speaker S6 of the channel C6 shown in FIG. 12 are also positioned in a travel direction of noise from the noise source 1000, the noise reaches the processing range prior to reaching the microphone M6. Therefore, a channel at a position opposite to the noise source with respect to the processing range need not be selected.

It should be noted that supply of sound signals from a microphone to the noise information acquiring unit 160 according to the third aspect is similar to the first to third examples of sound signal supply to the noise information acquiring unit 160 which have been described in the first aspect.

### 1-2-4. Fourth Aspect of Processing

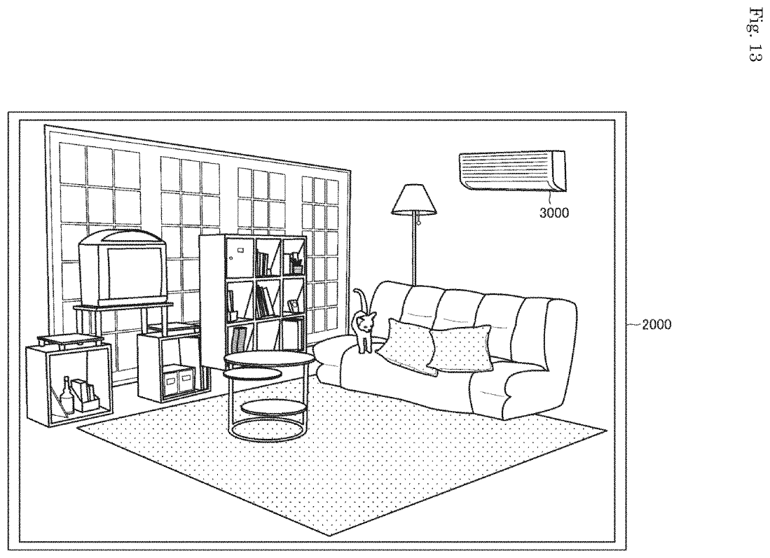

Next, a fourth aspect of processing by the noise information acquiring unit 160 will be described. In the fourth aspect, the noise information acquiring unit 160 is supplied with an image obtained by photographing a space that is a processing object of the signal processing apparatus 100 and performs predetermined image analysis processing on the image to acquire noise information. Performing subject recognition processing as the image analysis processing enables a position of a noise source in a space to be acquired. For example, when an image 2000 obtained by photographing a room as shown in FIG. 13 is supplied, an air conditioner 3000 as a noise source is recognized by subject recognition processing and a position thereof is acquired, or the like.

This can be performed by, for example, causing the noise information acquiring unit 160 to hold, in advance, data indicating external features of electrical home appliances, various devices, and the like which may become a noise source and carrying out subject recognition processing using feature value matching or the like.

In addition, an operation state of a noise source can be acquired by subject recognition processing. Furthermore, a travel direction of noise can be obtained by acquiring an orientation of a noise source by subject recognition processing. Moreover, by comprehending an object present within a space by subject recognition processing, a reflection direction, reflectance, and the like of noise in the space can also be acquired. When the reflection direction, the reflectance, and the like of noise are acquired as noise information, microphones and speakers of channels that are present in a direction in which noise travels by reflection may be selected.

It should be noted that the image may be an image photographed by a user using a digital camera or the like or an image taken by a monitoring camera, an automatic photographing camera, a household communication robot equipped with a camera function, or the like.

Channel selection processing when acquiring a position of a noise source from an image is similar to the first aspect described above. In addition, channel selection processing when acquiring a travel direction of noise from an image is similar to the second aspect described above.

When the noise source is an electrical home appliance or the like, switching of channel selections can be performed based on whether or not the noise source is working. For example, whether or not an electrical home appliance is operational can be determined by confirming whether or not an LED indicating on/off states of the electrical home appliance is turned on by subject recognition processing. In addition, for example, switching can be performed such that, when the electrical home appliance as a noise source is working, microphones and speakers positioned in a vicinity of the electrical home appliance are selected, but when the electrical home appliance is not working, channels are selected so that microphones and speakers are approximately uniformly arranged.

Alternatively, an electrical home appliance that may become a noise source and the signal processing apparatus 100 may be connected by the Internet using a method such as IoT (Internet of Things) and information on whether or not the electrical home appliance or the like is working may be acquired directly from the electrical home appliance.

In addition, when the reflection direction and the reflectance of noise in a space are acquired, selecting microphones and speakers arranged in the reflection direction of the noise enables the noise to be reduced in an efficient manner.

The first to fourth aspects of the noise information acquiring unit 160 are configured as described above.

It should be noted that when a user is aware of a position of a noise source, directionality of noise from a noise source, a working status of a noise source such as an electrical home appliance, or the like in advance, the user may directly input such information to the signal processing apparatus 100.

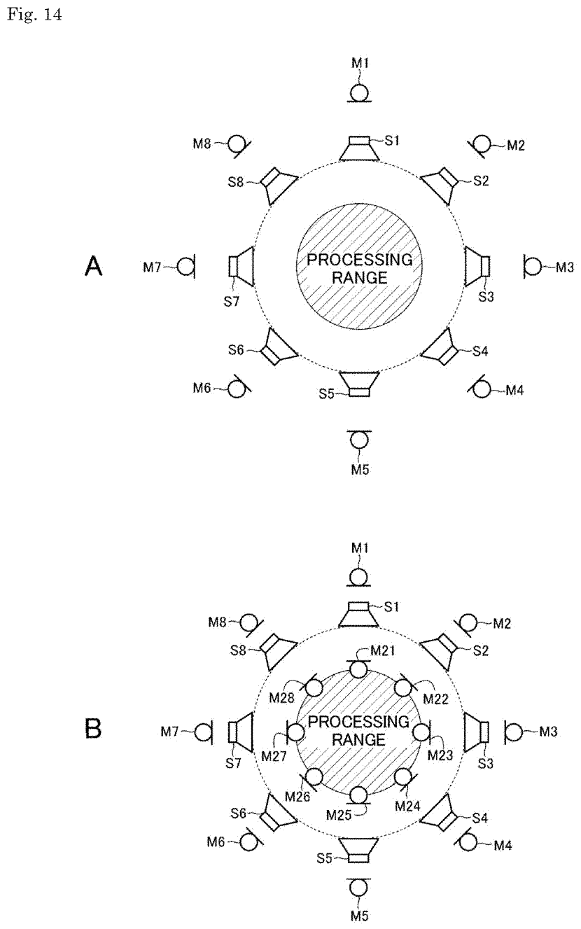

While an arrangement of microphones M and speakers S for noise cancellation processing by a feedback system has been described as an example in the embodiment, the present technique is also applicable to noise cancellation processing by a feedforward system as shown in FIG. 14A.

In addition, as shown in FIG. 14B, the present technique can be applied to a dual signal processing system which simultaneously uses a feedback system and a feedforward system. In the example shown in FIG. 14B, microphones M1 to M8 are reference microphones for the feedforward system and microphones M21 to M28 are error microphones for the feedback system. Either the error microphones M according to the feedback system or the reference microphones M according to the feedforward system may supply sound signals to the noise information acquiring unit 160.

Compared to a system that performs noise cancellation processing by simultaneously connecting all microphones M and speakers S, since the number of channels used for noise cancellation is smaller, it is also conceivable that noise reduction performance may decline. However, for example, in the feedforward system, noise needs to be collected and cancellation signals needs to be output without fail before the noise reaches a processing range. In the example shown in FIG. 14A, at the microphone M6 on an opposite side to a noise source 1000, since noise has already reached the processing range by the time it reaches the microphone M6, in such an arrangement, the microphone M6 and the speaker S6 do not contribute toward noise reduction.

In this manner, in noise reduction of a space, not all microphones and speakers make equal contributions toward processing of noise reduction, and whether or not a contribution is made has a lot to do with a position of a sound source. Therefore, even if there is a channel that does not contribute toward noise reduction, noise reduction performance does not decline and noise reduction can be performed efficiently in terms of resources, power, and cost.

As described above, according to the present technique, noise reduction can be performed using a smaller number of microphones and speakers than microphones and speakers that are being arranged. In other words, noise reduction can be performed using a smaller number of the AD converters 120 and the DA converters 130 than the number of microphones and speakers that are being arranged. Therefore, even with a noise cancellation processing unit with limited performance, noise reduction can be performed in an adequate manner. In addition, a processing range that is an object of noise reduction can be expanded without enhancing performance of the noise cancellation processing unit 110 and without increasing the number of the AD converters 120 and the DA converters 130.

### 2. Modifications

While an embodiment of the present technique has been described with specificity, it is to be understood that the present technique is not limited to the embodiment described above and that various modifications can be made based on the technical ideas of the present technique.

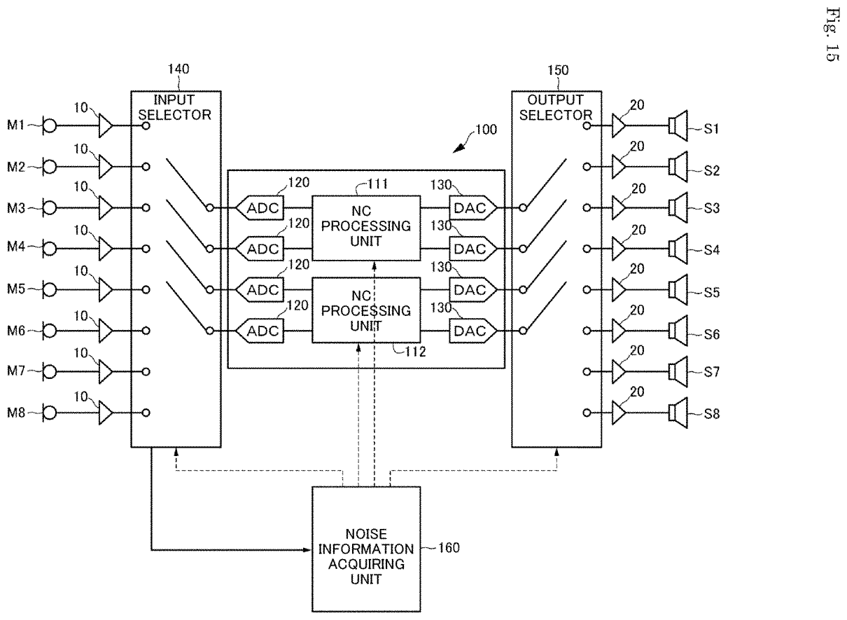

In the embodiment, a case of a single noise cancellation processing unit 110 has been described. However, as shown in FIG. 15, a plurality of noise cancellation processing units may be provided. In the example shown in FIG. 15, a total of two noise cancellation processing units are provided, namely, a first noise cancellation processing unit 111 and a second noise cancellation processing unit 112. Accordingly, a load applied to one noise cancellation processing unit can be reduced and securing of resources, acceleration of processing speed, and the like can be achieved. It should be noted that the number of noise cancellation processing units may be three or more.

In the embodiment, while a microphone for supplying a sound signal to the noise cancellation processing unit 110 and a microphone for supplying a sound signal to the noise information acquiring unit 160 are the same, alternatively, separate microphones may be used for sound signal supply to the noise cancellation processing unit 110 and for sound signal supply to the noise information acquiring unit 160.

In the embodiment, the noise information acquiring unit 160 selects a channel by referring to a table based on noise information and performs switching of channels by supplying a control signal to the input selector 140 and the output selector 150. However, selection of a channel based on noise information may be respectively performed by the input selector 140 and the output selector 150. In this case, the input selector 140 and the output selector 150 respectively hold a table in advance and, when noise information is supplied from the noise information acquiring unit 160, refer to the table to determine a channel to be selected and perform switching of channels. Accordingly, noise reduction similar to the embodiment can be realized.

Alternatively, one of the input selector 140 and the output selector 150 may be configured to perform selection of a channel. For example, in the case of a configuration in which only the input selector 140 holds a table and the output selector 150 does not hold a table, the input selector 140 determines a channel to be selected and outputs a predetermined control signal to the output selector 150. Based on the control signal, the output selector 150 selects a same channel as the channel selected by the input selector 140. Accordingly, noise reduction similar to the embodiment can be realized.

A sound content signal may be supplied from a sound source 300 to the noise cancellation processing unit 110 via a digital I/F 200. The sound source 300 may be various media players such as a music player, a DVD player, a Blue-ray (registered trademark) player, and a car stereo. A sound content signal output from the sound source 300 is a sound signal reproduced by the media player. The sound content signal is heard by a user as sound contents within a processing range of noise cancellation by the signal processing apparatus 100.

When the user hears sound contents from the sound source 300 within the processing range of the signal processing apparatus 100, the sound contents reproduced from the sound source 300 within the processing range are input to a microphone together with noise. Subsequently, using the sound content signal supplied via the digital I/F 200 in the noise cancellation processing unit 110, the sound contents is removed from a signal constituted by the sound contents and noise to generate a signal constituted solely by the noise. By generating a cancellation signal from the signal constituted solely by the noise and outputting the cancellation signal from a speaker, only noise can be reduced without affecting the sound contents being reproduced from the sound source 300 within the processing range.

Furthermore, when using the signal processing apparatus 100 in a room or a vehicle, a common speaker may be used as a speaker for sound content output and a speaker for cancellation signal output. In such a case, only noise is reduced and the sound contents being output from the speaker is not reduced. To this end, the sound source 300 is connected to the signal processing apparatus 100 via the digital I/F 200 and a sound content signal is supplied to the noise cancellation processing unit 110. Subsequently, by removing the sound content signal from a signal constituted by sound contents and noise which have been collected by a microphone, a signal constituted solely by the noise is generated. By generating a cancellation signal from the signal constituted solely by the noise and using the cancellation signal, only noise can be reduced without reducing the sound contents from the sound source 130 within the processing range.

In the embodiment, while cancellation signals are not simultaneously output from all speakers and cancellation signals are output from fewer than all of the speakers, cancellation signals may be arranged to be output from fewer than all of the speakers using the present technique while enabling output of cancellation signals from all speakers.

In addition, artificial intelligence, a neural network, or the like may be used in acquisition of noise information based on a sound signal and selection of a channel based on the noise information so that accuracy increases as frequency of use increases.

The present technique can also be configured as follows.

(1)

A signal processing apparatus that performs noise cancellation processing for reducing noise by selecting, from among a plurality of input units and a plurality of output units that respectively correspond to the plurality of input units, the input unit and the output unit to be used in noise cancellation processing.

(2)

The signal processing apparatus according to (1) that, wherein the signal processing apparatus acquires information related to the noise and performs switching of selections of the input unit and the output unit based on the information related to the noise.

(3)

The signal processing apparatus according to (2), wherein the information related to the noise is a position of a noise source that generates the noise.

(4)

The signal processing apparatus according to (3), wherein the signal processing apparatus acquires the position of the noise source based on a level of a sound signal input from the input unit.

(5)

The signal processing apparatus according to (3) or (4), wherein the signal processing apparatus selects one or a plurality of the input units that are close to the position of the noise source among the plurality of input units and the output units that correspond to the selected input units.

(6)

The signal processing apparatus according to any one of (2) to (5), wherein the information related to the noise is frequency characteristics of the noise.

(7)

The signal processing apparatus according to (6), wherein when a high-frequency component of the frequency characteristics is equal to or smaller than a predetermined value, the one or a plurality of the input units and the output units are selected such that the input units and the output units to be used in noise cancellation processing are approximately uniformly arranged.

(8)

The signal processing apparatus according to any one of (2) to (7), wherein the information related to the noise is directionality of the noise.

(9)

The signal processing apparatus according to (8), wherein the signal processing apparatus selects one or a plurality of the input units and the output units that are positioned on an extension of a direction in which the directionality of the noise is high.

(10)

The signal processing apparatus according to (8) or (9), wherein when the directionality of the noise is low, the one or a plurality of the input units and the output units are selected such that the input units and the output units to be used in noise cancellation processing are approximately uniformly arranged.

(11)

The signal processing apparatus according to any one of (2) to (10), wherein the information related to the noise is information indicating reflection of the noise.

(12)

The signal processing apparatus according to (11), wherein the signal processing apparatus selects, by the reflection, one or a plurality of the input units that are close to a position to which the noise is directed and the output units that correspond to the selected input units.

(13)

The signal processing apparatus according to any one of (2) to (12), wherein the information related to the noise is acquired based on an image obtained by photographing a space to be an object of noise cancellation processing.

(14)

The signal processing apparatus according to (2), wherein the information related to the noise is input by a user.

(15)

A signal processing method including: performing noise cancellation processing for reducing noise by selecting, from among a plurality of input units and a plurality of output units that respectively correspond to the plurality of input units, the input unit and the output unit to be used in noise cancellation processing.

(16)

A signal processing program that causes a computer to execute a signal processing method including performing noise cancellation processing for reducing noise by selecting, from among a plurality of input units and a plurality of output units that respectively correspond to the plurality of input units, the input unit and the output unit to be used in noise cancellation processing.

### REFERENCE SIGNS LIST

100 Signal processing apparatus

110 Noise cancellation processing unit

M Microphone

S Speaker

1. A signal processing apparatus that performs noise cancellation processing for reducing noise by selecting, from among a plurality of input units and a plurality of output units that respectively correspond to the plurality of input units, the input unit and the output unit to be used in noise cancellation processing.

2. The signal processing apparatus according to claim 1, wherein
the signal processing apparatus acquires information related to the noise and performs switching of selections of the input unit and the output unit based on the information related to the noise.

3. The signal processing apparatus according to claim 2, wherein
the information related to the noise is a position of a noise source that generates the noise.

4. The signal processing apparatus according to claim 3, wherein
the signal processing apparatus acquires the position of the noise source based on a level of a sound signal input from the input unit.

5. The signal processing apparatus according to claim 3, wherein
the signal processing apparatus selects one or a plurality of the input units that are close to the position of the noise source among the plurality of input units and the output units that correspond to the selected input units.

6. The signal processing apparatus according to claim 2, wherein
the information related to the noise is frequency characteristics of the noise.

7. The signal processing apparatus according to claim 6, wherein
when a high-frequency component of the frequency characteristics is equal to or smaller than a predetermined value, the one or a plurality of the input units and the output units are selected such that the input units and the output units to be used in noise cancellation processing are approximately uniformly arranged.

8. The signal processing apparatus according to claim 2, wherein
the information related to the noise is directionality of the noise.

9. The signal processing apparatus according to claim 8, wherein
the signal processing apparatus selects one or a plurality of the input units and the output units that are positioned on an extension of a direction in which the directionality of the noise is high.

10. The signal processing apparatus according to claim 8, wherein
when the directionality of the noise is low, the one or a plurality of the input units and the output units are selected such that the input units and the output units to be used in noise cancellation processing are approximately uniformly arranged.

11. The signal processing apparatus according to claim 2, wherein
the information related to the noise is information indicating reflection of the noise.

12. The signal processing apparatus according to claim 11, wherein
the signal processing apparatus selects, by the reflection, one or a plurality of the input units that are close to a position to which the noise is directed and the output units that correspond to the selected input units.

13. The signal processing apparatus according to claim 2, wherein
the information related to the noise is acquired based on an image obtained by photographing a space to be an object of noise cancellation processing.

14. The signal processing apparatus according to claim 2, wherein
the information related to the noise is input by a user.

15. A signal processing method comprising:
performing noise cancellation processing for reducing noise by selecting, from among a plurality of input units and a plurality of output units that respectively correspond to the plurality of input units, the input unit and the output unit to be used in the noise cancellation processing.

16. A signal processing program that causes a computer to execute
a signal processing method including performing noise cancellation processing for reducing noise by selecting, from among a plurality of input units and a plurality of output units that respectively correspond to the plurality of input units, the input unit and the output unit to be used in the noise cancellation processing.
